(19) United States
(12) Patent Application Publication
(10) Pub. No.: US 2002/0120086 A1
(43) Pub. Date: Aug. 29, 2002

(54) Quaternary polymers with functional amine groups field of the invention

(76) Inventors: Peter Wendling, Leverkusen (DE); Lothar Reif, Dormagen (DE); Jurgen Trimbach, Koln (DE); Adrian Rawlinson, Leverkusen (DE); Rolf Peter, Dormagen (DE)

Correspondence Address: BAYER CORPORATION, PATENT DEPARTMENT, 100 BAYER ROAD, PITTSBURGH, PA, 15205, US

(21) Appl. No.: 09/948,036

(22) Filed: Sep. 5, 2001

(30) Foreign Application Priority Data
Sep. 8, 2000 (DE) 10044399.0

(51) Int. Cl. C08F 136/00

(52) U.S. Cl. 526/335; 526/346; 526/341

(57) ABSTRACT

The invention relates to quaternary polymers, based on conjugate dienes, vinyl-substituted aromatic compounds, olefinically unsaturated nitriles and amino group-containing monomers. The rubber vulcanizates or molded articles, in particular tires, produced from the quaternary polymers or their mixtures with other rubbers are balanced out by good mechanical properties, in particular by a desirable balance in relation to the rolling resistance, skid resistance in the wet and abrasion, which is of particular advantage in tire construction.

### FIELD OF THE INVENTION

The invention relates to quaternary polymers, based on conjugate dienes, vinyl-substituted aromatic compounds, olefinically unsaturated nitriles and amino group-containing monomers, their production and use in rubber compounds and for producing rubber molded articles of all kinds.

### BACKGROUND OF THE INVENTION

Rubber mixtures are used for producing rubber products for the most varied of applications. Different demands are made of the corresponding rubber mixture in accordance with the area of application. Therefore, in addition to the rubber components, the rubber mixture contains further components such as fillers, antioxidants and vulcanizing agents which fundamentally influence the properties of the finished rubber product. Special significance is attached to the fillers in particular. Only the appropriate combination consisting of rubbers and fillers and optionally further components lead to optimal results in the sense of the objects posed. One development aim of recent years in the tire sector was to improve the rolling resistance, i.e. a reduction in fuel on economic and ecological grounds. At the same time, losses in skid resistance in the wet and wear were to be avoided. Vulcanizates based on carbon black exhibit good mechanical properties, but a high degree of rolling resistance and poor skid resistance in the wet are observed in mixtures for tire treads. Use of silica and filler activators, such as bis-3-(triethoxysilylpropyl)tetra-sulfide in combination with the rubber component, SBR solution, and optionally other rubbers led to tread mixtures with low rolling resistance and good skid resistance in the wet. In the course of this development, the property profile of SBR solution was optimized for use in silica mixtures. SBR emulsion cannot attain this property profile with regard to silica mixtures.

Advantages in silica mixtures in terms of rolling resistance and abrasion in comparison with ESBR are shown in EP-A 0 819 731 for terpolymers produced in emulsion and consisting of amino group-containing monomers, butadiene and styrene. The same advantages are shown in EP-A 0 849 321, wherein the vulcanization accelerator is a sulfenamide compound. Advantages of silica mixtures in terms of rolling resistance and abrasion in comparison with ESBR are also shown in EP-A 0926 192 for terpolymers produced in emulsion and consisting of vinyl pyridine, butadiene and styrene. Although the terpolymers presented in the above-mentioned European patent publications exhibit improved rolling resistance and abrasion in comparison with ESBR, these two parameters can be improved further, as can the important property of skid resistance in the wet. DE-A 19 643 035 describes terpolymers containing butadiene, styrene and acrylonitrile. These polymers are distinguished by high skid resistance in the wet, which does however require improvement.

### SUMMARY OF THE INVENTION

The object of the present invention is accordingly to provide rubbers which exhibit a more favorable balance in relation to the rolling resistance, the skid resistance in the wet and abrasion.

It has now been found that quaternary polymers based on conjugate dienes, vinyl aromatic compounds, olefinically unsaturated nitriles and amino group-containing monomers have an improved property portfolio in relation to the above-mentioned parameters.

Therefore, the invention relates to quaternary polymers containing

(a) 40 to 95 wt. % of a conjugate diene,

(b) 1 to 30% of a vinyl-substituted aromatic,

(c) 1 to 30 wt. % of an olefinically unsaturated nitrile and

(d) 0.1 to 20 wt. % of an amino group-containing monomer,

wherein the components (a) to (d) in each case add up to 100 wt. %.

### DETAILED DESCRIPTION OF THE INVENTION

Quaternary polymers which contain 50 to 90 wt. %, preferably 55 to 85 wt. % of a conjugate diene; 5 to 30 wt. %, preferably 10 to 30 wt. % of a vinyl-substituted aromatic; 5 to 30 wt. %, preferably 10 to 25 wt. % of an olefinically unsaturated nitrile; and 0.5 to 15 wt. %, preferably 1.0 to 10 wt. % and, more preferably 1.0 to 6 wt. % of an amino group-containing monomer are utilized.

Preferred examples of conjugate dienes according to the present invention are conjugate dienes with 4 to 8 carbon atoms, for example 1,3-butadiene, isoprene, chloroprene, 1,3-pentadiene, 2,3-dimethyl-1,3-butadiene, 2-methyl-1,3-pentadiene and 2,3-dimethyl-1,3-pentadiene and mixtures thereof. 1,3-butadiene and isoprene are preferably used, more preferably 1,3-butadiene.

Vinyl-substituted aromatics, preferably those with 8 to 12 carbon atoms are used, for example styrene, α-methylstyrene, p-methylstyrene, 1-vinyinaphthalene, p-chlorostyrene and p-bromostyrene. Styrene is preferably used. The vinyl-substituted aromatics can obviously be used alone or in a mixture with one another.

Examples of suitable olefinically unsaturated nitrites are those with 3 to 6 carbon atoms, such as acrylonitrile, methacrylonitrile, 3-butenenitrile and 4-pentenenitrile. Acrylonitrile and methacrylonitrile, in particular acrylonitrile, are preferred. The above-mentioned nitrites can also be used individually or in any mixture with one another.

Examples of amino group-containing monomers include all of the monomers which are polymerizable with the aforementioned monomers and contain at least one amino group. The amino group can be of a primary, secondary or tertiary nature. Monomers with a primary or tertiary amino group, in particular with a tertiary amino group, are preferred. The amino group-containing monomers can in turn be used alone or combined with other amino group-containing monomers.

Examples of suitable monomers with primary amino groups are mentioned in EP-A 0 849 321 on page 3, lines 12 to 14. These are: acrylamide, methylacrylamide, p-aminostyrene, aminomethylacrylate, aminomethylmethacrylate, aminoethylacrylate, aminoethylmethacrylate, aminopropylacrylate, aminopropylmethacrylate, aminobutylacrylate and aminobutylmethacrylate.

Examples of amino group-containing monomers with secondary amino groups are mentioned in EP-A 0 849 321 on page 3, lines 15 to 19. Examples are: anilinostyrene, anilinophenylbutadiene, methylacrylamide, ethylacrylamide, methylmethacrylamide, ethylmethacrylamide, N-monosubstituted acrylamide, such as N-methylolacrylamide, and N-monosubstituted methacrylamide, such as N-(4-anilino-phenyl)methacrylamide.

Suitable amino group-containing monomers with tertiary amino groups are also listed in the above-mentioned European patent publication on page 3, lines 20 to 23. Examples are: N,N-disubstituted aminoalkylacrylate, N,N-disubstituted aminoalkylmethacrylate, N,N-disubstituted aminoalkylacrylamide, N,N-disubstituted aminoalkyl-acrylomethamide, N,N-disubstituted aminoaromatic vinyl compounds and vinyl compounds-containing pyridyl groups.

Examples of amino group-containing monomers are mentioned in EP-A-0 849 321 on page 3 in lines 24 to 56. These are for example: N,N-dimethylaminomethylacrylate, N,N-dimethylaminomethylmethacrylate, N,N-dimethylaminoethylacrylate, N,N-dimethylaminoethylmethacrylate, N,N-dimethylaminopropylacrylate, N,N-dimethylaminopropylmethacrylate, N,N-dimethylaminobutylacrylate, N,N-dimethylaminobutylmethacrylate, N-methyl-N-ethylaminoethylacrylate, N-methyl-N-ethylaminoethylmethacrylate, N,N-dipropylaminoethylacrylate, N,N-dipropylaminoethylmethacrylate, N,N-dibutylaminoethylacrylate, N,N-dibutylaminoethylmethacrylate, N,N-dibutylaminopropylacrylate, N,N-dibutylaminopropylmethacrylate, N,N-dibutylaminobutylacrylate, N,N-dibutylaminobutylmethacrylate, N,N-dihexylaminoethylacrylate, N,N-dihexylaminoethylmethacrylate, N,N-dioctylaminoethylacrylate, N,N-dioctylaminoethylmethacrylate and acryloylmorpholine. Examples of acrylic acid esters are: N,N-dimethylaminoethylacrylate, N,N-diethylaminoethylacrylate, N,N-dipropylaminoethylacrylate, N,N-dioctylaminoethylacrylate and N-methyl-N-ethylaminoethylacrylate. Examples of methacrylic acid esters are: N,N-dimethylaminomethylmethacrylate, and N,N-diethylaminoethylmethacrylate, N,N-dipropylaminoethylmethacrylate. Preferred amino group-containing monomers are N-dioctylaminomethylmethacrylate and N-methyl-N-ethylaminoethylmethacrylate.

Specific examples of N,N-disubstituted aminoalkylacrylamides and N,N-disubstituted aminoalkylmethacrylamides are: N,N-dimethylaminomethylacrylamide, N,N-dimethylaminomethylmethacryl-amide, N,N-dimethylaminoethylacrylamide, N,N-dimethylaminoethylmethacrylamide, N,N-dimethylaminopropylacrylamide, N,N-dimethylaminopropylmethacrylamide, N,N-dimethylamino butylacrylamide, N-N-dimethylaminobutylmethacrylamide, N,N-diethylaminoethylacrylamide, N,N-diethylaminoethylmethacrylamide, N,N-diethylaminopropylacrylamide, N,N-diethylaminopropylmethacrylamide, N,N-diethylaminobutylacrylamide,N,N-diethylaminobutylmethacrylamide, N-methyl-N-ethyl-aminoethylacrylamide, N-methyl-N-ethyl-aminoethylmethacrylamide, N,N-dipropylaminoethylacrylamide, N,N-dipropylaminoethylmethacrylamide, N,N-dibutylaminoethylacrylamide, N,N-dibutylaminoethylmethacrylamide, N,N-dibutylaminopropylacrylamide, N,N-dibutylaminopropylmethacrylamide, N,N-dibutylaminobutylacrylamide, N,N-dibutylaminobutylmethacrylamide, N,N-dihexylaminoethylacrylamide, N,N-dihexylaminoethylmethacrylamide, N,N-dihexylaminopropylacrylamide, N,N-dihexylaminopropylmethacrylamide, N-N-dioctylaminopropylacrylamide and N,N-dioctylaminopropylmethacrylamide. Preferred examples of N,N-disubstituted aminoalkylacrylamides or N,N-disubstituted aminoalkylmethacrylamides are N,N-dimethylaminopropylacrylamide, N,N-dimethylaminopropylmethacrylamide, N,N-diethylaminopropylacrylamide, N,N-diethyl-aminopropylmethacrylamide, N,N-dioctylaminopropylacrylamide and N,N-dioctylaminopropylmethacrylamide.

Specific examples of N,N-disubstituted amino aromatic compounds are: N,N-dimethylaminoethylstyrene, N,N-diethylaminoethylstyrene, N,N-dipropylaminoethylstyrene and N,N-dioctylaminoethylstyrene.

Specific examples of compounds which contain pyridyl groups are: 2-vinylpyridine, 4-vinylpyridine, 5-methyl-2-vinylpyridine and 2-ethyl-2-vinylpyridine. 2-vinylpyridine and 4-vinylpyridine are preferred.

The quaternary polymers according to the present invention can, in principle, be prepared in solution, suspension or emulsion, preparation in emulsion being preferred.

The present invention, therefore, also relates to the production of quaternary polymers according to the present invention in that the polymerization of the above-mentioned components is carried out in emulsion in a known manner.

Polymerization in emulsion can be carried out both intermittently and continuously. Of course, it is also possible to supply the monomers to be used incrementally to the polymerization.

The emulsion polymerization can be carried out in the presence of anionic, cationic or non-ionic emulsifiers or mixtures thereof, of the type conventionally used for emulsion polymerization. The pH is conventionally 2 to 13 and is adapted to the emulsifiers used.

Examples of emulsifiers are: salts of disproportionated resin acid, of unmodified resin acid, of fatty acids and fatty acid mixtures, alkyl-, aryl-, alkarylsulfonic acids and sulfates and mixtures thereof.

Known auxiliary agents, such as salts, chain transfer agents and complexing agents can also be used in the emulsion polymerization. Examples of salts are phosphates, chlorides, carbonates and sulfides. Examples of chain transfer agents are mercaptans and xanthogen disulfides. Dodecyl mercaptans are preferred and tert.-dodecyl mercaptan and those tert.-dodecyl mercaptans derived from isobutylene as a structural unit, that means it contains at least three tertiary carbon atoms and having a sulfur atom which is directly bound to at least one of the tertiary carbon atoms are particularly preferred. An example of a common complexing agent is the sodium salt of ethylenediamine tetraacetic acid.

Examples of initiators for the polymerization are the known, radical-donating compounds such as peroxides, hydrogen peroxides, persulfates and redox systems, such as hydroperoxide-sodium formaldehyde sulfoxylate iron. Complexing agents such as the above-mentioned sodium salt of ethylenediamine tetraacetic acid can be helpful when using iron. The menthane hydroperoxide-sodium formaldehyde sulfoxylate iron sodium salt of ethylenediamine tetraacetic acid redox system is preferred.

Polymerization in emulsion can be carried out at temperatures in the range of 0 to 100° C., preferably at 5 to 20° C. The monomers used are conventionally polymerized up to a monomer conversion of 50 to 90 wt. %, preferably 60 to 80 wt. %, based on the total quantity of monomers used. After reaching the desired monomer conversion the polymerization is terminated with the known short stopping agent, for example with the aid of cresols, diethylhydroxylamine, dithiocarbamates or sodium dithionite and mixtures thereof. It may be helpful in this case to add known antioxidants, for example sterically hindered phenols and amine- and/or phosphide-containing antioxidants, to the quaternary polymers obtained. Such antioxidants are preferably added in the latex stage. In addition, plasticizers and/or extending oils can be added, also preferably in the latex stage.

The quaternary polymers according to the present invention are isolated from the latex in a known manner by coagulation, for example by the addition of acids, salts or organic polyelectrolytes and mixtures thereof. Coagulation can also be initiated by lowering or raising the temperature and/or shearing.

After coagulation has taken place, the quaternary polymer is isolated, washed with water, optionally dehydrated in suitable apparatuses and subsequently dried.

Such emulsion polymerization processes and the auxiliary agents used in the process are generally known and are described in more detail, for example, in Houben-Weyl, Methoden der organischen Chemie, volume 14/1, Georg Thieme Verlag Stuttgart (1961); Ullmann's Encyclopedia of Industrial Chemistry, Vol. A23, Rubber, 3. Synthetic, VCH Verlagsgesellschaft mbH Weinheim (1993).

The quaternary polymers obtained according to the present invention have a Mooney viscosity of 20 to 150, preferably 30 to 120, measured to DIN 53523, and a glass transition temperature (Tg value) in the range of −5 to −70° C., preferably −10 to −60° C. The quaternary polymers obtained according to the present invention also have a gel content of 0.01 to 20%, preferably 0.01 to 10%, more preferably 0.01 to 3%.

The present invention also relates to the use of the quaternary polymers for producing molded articles of all kinds, in particular for producing tires, belts, tubes and seals. Production of tires and tire treads is most preferred.

The present invention also relates to rubber mixtures containing the quaternary polymers according to the present invention and other natural or synthetic rubbers or mixtures of natural or synthetic rubbers and optionally fillers of all kinds and other rubber property-improving auxiliary agents.

Rubber mixtures, which contain 5 to 90, preferably 10 to 80 parts by weight of the quaternary polymers according to the present invention, 10 to 95, preferably 20 to 90 parts by weight of natural or synthetic rubbers or mixtures of natural or synthetic rubbers and 10 to 150, preferably 20 to 100 parts by weight of fillers are preferred.

As mentioned, the rubber mixtures according to the present invention can, in addition to natural rubber, also contain other synthetic rubbers alone or in combination with one another, such as polybutadiene, polyisoprene, polychloroprene, styrene butadiene copolymers, styrene isoprene copolymers, isoprene butadiene styrene copolymers, acrylonitrile butadiene copolymers, acrylonitrile styrene butadiene terpolymers, carboxylated acrylonitrile butadiene copolymers, hydrogenated acrylonitrile butadiene copolymers, ethylene propylene diene terpolymers.

The quaternary polymers according to the present invention can be mixed with other rubbers by means of a mixer, such as a roller or a kneader. Mixing of the quaternary polymers according to the present invention with other rubbers in the form of lattices is also possible.

As mentioned, the rubber mixtures according to the present invention can also contain other conventional auxiliary agents which improve the rubber properties, and the conventional cross-linking agents. Examples of additives are: fillers, pigments, zinc oxide, stearic acid, vulcanization accelerators, antioxidants, plasticizers, wax, extending oils, tackifying agents and plasticizing agents. The above-mentioned additives are used in conventional quantities which are known to the person skilled in the art.

Suitable accelerators are, for example, amines, guanidines, thioureas, thiazoles, thiurams, dithiocarbamates, xanthates and sulfenamides. The appropriate quantities of additives are known to the person skilled in the art. Elementary sulfur and sulfur-donors such as dithiocarbamates, thiurampolysulfides and other polysulfides can, for example, be used for sulfur vulcanization. The appropriate quantities are known to the person skilled in the art. Phenols, bisphenols, thiobisphenols, polyphenols, hydroquinones, amines such as naphthylamines, diphenylamines, diarylamines and phosphites are suitable antioxidants. Conventional quantities of antioxidants are 0.1 to 10 parts by weight based on rubber.

The known carbon blacks and silicas as well as silicates, titanium dioxide, chalk and clay are suitable as fillers for the rubber mixtures according to the present invention. The fillers can be used both alone and in combination with the other fillers. Use of silica is preferred.

Suitable carbon blacks are, for example, those which were produced by the lamp black process, furnace process or gas black process and have a BET surface area of 20 to 200 m²/g. Examples are SAF-, ISAF-, HAF-, FEF- or GPB-carbon blacks.

Suitable silicas are, for example, those with BET surface areas of approximately 30 to 272 m²/g and a CTAB index of approximately 120 to 285 m²/g.

So-called filler activators, such as bis-3-(triethoxysilypropyl)tetra-sulfide can also be added when using silicas in the rubber mixtures.

The above-mentioned additives and auxiliary agents are, as mentioned, known to the person skilled in the art, likewise the quantities to be used, and are described inter alia in Kautschuk-Technologie by Werner Hofmann, Habilitationsschrift Fakultat fur Maschinenwesen, TH Aachen 1975; Manual for the Rubber Industry Bayer AG Leverkusen (1993).

Rubber molded articles of all kinds, in particular those mentioned above, may be produced from the rubber mixtures according to the present invention.

The present invention also relates to rubber molded articles of all kinds, in particular tires, tire components such as tire treads and side walls, belts, tubes and seals which are characterized in that they are produced in a shaping manner by a suitable vulcanization process using the above-mentioned rubber mixtures.

In the following examples, the properties of the rubbers according to the present invention, the comparison rubbers and the resulting vulcanizates were measured as follows:

(1) The polymer composition was measured by ¹H-NMR.

(2) The Mooney viscosity of the rubbers was determined to DIN 53523.

(3) The tensile strength of the vulcanizates was determined to DIN 53504.

(4) The elongation at break of the vulcanizates was determined to DIN 53504.

(5) The modulus of the vulcanizates at 100, 200 and 300% elongation was determined to DIN 53504.

(6) The hardness of the vulcanizates at 70° C. was determined to DIN 53505.

(7) The abrasion of the vulcanizates was determined to DIN 53516.

(8) The tan 6 of the vulcanizates was determined to DIN 53513.

(9) The gel content was measured in toluene as follows:

100 to 150 mg of rubber were allowed to stand for 12 to 16 hours in 20 ml toluene and then shaken for 2 hours. After centrifuging off the insoluble portion this was dried, weighed out and specified as a percentage of the weighed-in rubber.

### EXAMPLES

1. Production and characterization of the quaternary polymers according to the present invention.

### Example 1

860.63 g styrene, 12.94 g tert. dodecylmercaptan (manufactured by Bayer AG), 450.00 g acrylonitrile, 151.88 g of a mixture consisting of styrene and 2-vinylpyridine 1:1 and a solution consisting of 7969.92 g completely desalinated water, 197.68 g disproportionated resin acid (70% sodium salt), 2060.53 g partially hydrated tallow fatty acid (9.5% sodium salt), 14.06 g potassium hydroxide (85%), 32.06 g condensed naphthalene sulfonic acid (sodium salt) and 14.63 g potassium chloride and 4162.50 g butadiene were placed in an evacuated, stirrable 20 liter steel reactor and the temperature adjusted to 10° C. The polymerization was initiated by adding 1.01 g p-menthane hydroperoxide (50%) and a solution consisting of 223.88 g completely desalinated water, 1.13 g EDTA, 0.90 g iron (II) sulfate*7H₂O, 2.31 g sodium formaldehyde sulfoxylate and 3.49 g sodium phosphate*12 H₂O and continued while stirring at 10° C.

The polymerization was stopped short at a conversion of 80% by adding 22.5 g diethylhydroxylamine (25%) and 1.13 g sodium dithionite. 13.50 g Vulkanox® BKF (2,2′-methylene-bis-(4-methyl-6-tert.-butylphenol, produced by Bayer AG Leverkusen) were added to the latex as 46% dispersion (29.35 g). The butadiene which was not reacted was de-gassed and the monomers which were not reacted were removed by means of steam. 80 l of completely desalinated water (60° C.) were added to the de-gassed latex while stirring and the latex was precipitated by adding 100 parts by weight of sodium chloride and 0.25 parts by weight of polyamine (Superfloc® C567) based on rubber at pH 4 while adding 10% sulfuric acid at 60° C. The polymer obtained was filtered off and washed while stirring with completely desalinated water at 65° C. The moist rubber was dried at 70° C. in the vacuum drying cabinet to a residual moisture content of <0.5%.

The Mooney viscosity of the polymers obtained was 62 (ME).

The examples 2-6 according to the present invention were produced in the same way. Table 1 shows an overview of the monomer mixture used and of the Mooney viscosity and of the gel content of the polymers obtained.

TABLE 1

| | Example | Example | Example | Example | Example | Example | Example | Example |
|---|---|---|---|---|---|---|---|---|
| | 1 | 2 | 3 | 4 | 5 | 6 | 7 | 8 |
| Monomer | (wt.-%) | (wt.-%) | (wt.-%) | (wt.-%) | (wt.-%) | (wt.-%) | (wt.-%) | (wt.-%) |
| Butadiene | 74.00 | 70.00 | 74.00 | 74.00 | 74.00 | 72.00 | 55.00 | 55.00 |
| Styrene | 16.65 | 16.00 | 14.14 | 14.00 | 16.41 | 16.00 | 25.14 | 25.00 |
| Acrylonitrile | 8.00 | 10.00 | 8.00 | 8.00 | 8.00 | 8.00 | 16.00 | 16.00 |
| 2-vinylpyridine | 1.35 | | | | | | | |
| 2-vinylpyridine | | 4.00 | | | | | | |
| Dimethylaminopropylmethacrylamide | | | 3.86 | | | | | |
| 2-acrylamido-2-methylpropanesulfonic acid | | | | 4.00 | | | | |
| Methacrylamide | | | | | 1.59 | | | |
| 2-vinylpyridine | | | | | | 4.00 | | |
| Dimethylaminopropylmethacrylamide | | | | | | | 3.86 | |
| 2-vinylpyridine | | | | | | | | 4.00 |
| Total of Monomere | 100.00 | 100.00 | 100.00 | 100.00 | 100.00 | 100.00 | 100.00 | 100.00 |
| Mooney-Viskosity (ME) | 62 | 64 | 59 | 80 | 66 | 43 | 46 | 58 |
| Gel content in toluene (%) | 1.9 | 2.3 | 3.7 | 2.4 | 1.4 | 1.3 | 1.5 | 0.9 |

The polymer composition of Example 1, 2, 3, 6, 7 and 8 was determined by ¹HNMR. The polymer composition of Examples 4 and 5 was estimated by IR spectroscopy. The results are summarized in Tables 2 and 3.

TABLE 2

| | | Example | Example | Example | Example |
|---|---|---|---|---|---|
| | | 1 | 2 | 3 | 4 |
| 1,2-Butadiene | (wt-%) | 12.6 | 11.9 | 12/9 | 11/4 |
| 1,4-Butadiene | (wt-%) | 64.5 | 61.1 | 65.9 | 68.7 |
| Styrene | (wt-%) | 13.4 | 12.3 | 11.7 | 11.0 |
| Acrylonitrile | (wt-%) | 8.2 | 10.9 | 8.5 | 8.5 |
| 2-vinylpyridine | (wt-%) | 1.3 | | | |
| 2-vinylpyridine | (wt-%) | | 3.8 | | |
| Dimethylaminopropylmethacrylamide | (wt-%) | | | 1.0 | |
| 2-acrylamido-2-methylpropanesulfonic | (wt-%) | | | | about 0.5 |

TABLE 3

| | | Example | Example | Example | Example |
|---|---|---|---|---|---|
| | | 5 | 6 | 7 | 8 |
| 1,2-Butadiene | (wt.-%) | 11.0 | 12.3 | 9.0 | 8.4 |
| 1,4-Butadiene | (wt.-%) | 67.2 | 62.9 | 51.4 | 50.4 |
| Styrene | (wt.-%) | 12.9 | 12.3 | 20.9 | 20.2 |
| Acrylonitrile | (wt.-%) | 8.7 | 8.6 | 17.1 | 17.3 |
| Methacrylamide | (wt.-%) | about | | | |
| | | 1.5-2 | | | |
| 2-vinylpyridine | (wt.-%) | | 3.9 | | |
| Dimethylaminopropylmethacrylamide | (wt.-%) | | | 1.6 | |
| 2-vinylpyridine | (wt.-%) | | | | 3.8 |

2. Comparison Examples

Comparison example 9 is a styrene butadiene copolymer (Buna VSL 5025-0®, vinyl content 50%, styrene content 25%, manufacturer Bayer AG) produced in solution.

Comparison example 10 is a styrene butadiene copolymer (Krylene® 1500, styrene content 23.5%, manufacturer Bayer AG) produced in emulsion.

Comparison example 11 is a rubber corresponding to the disclosure in EP-A 0 926 192 and EP-A 0 819 731. Production is by emulsion polymerization as with the rubbers according to the present invention, wherein a monomer mixture consisting of 71 wt. % butadiene, 24.96 wt. % styrene and 4.04 wt. % 2-vinylpyridine was used. The Mooney viscosity of the rubber is 68 ME. The polymer composition was determined by ¹HMR (12.4% 1,2-butadiene, 63.9% 1,4-butadiene, 19.5% styrene, 4.2% vinylpyridine).

Comparison example 12 was produced in accordance with the rubbers according to the present invention, wherein a monomer mixture consisting of 74 wt. % butadiene, 18 wt. % styrene and 8 wt. % acrylonitrile was used. The Mooney viscosity of the rubber is 78 ME. The polymer composition was determined by ¹HMR (12.7% 1,2-butadiene, 64.3% 1,4-butadiene, 14.2% styrene, 8.8% acrylonitrile). This example represents the prior art according to DE-A 19 643 035.

2. Testing of the polymers according to the present invention and the comparison polymers in silica mixtures.

The following mixture was used:

TABLE 4

| | |
|---|---|
| TSR 5, Defo 700 | 10 |
| Buna CB 25 | 30 |
| 3^{rd} rubber | 60 |
| Vulkasil S | 70 |
| Silane Si 69 | 5.6 |
| Carbon black Corax N 121 | 10 |
| Enerthene 1849-1 | 37.5 |
| ZnO RS | 2.5 |
| Stearic acid | 1 |
| Antilux 654 | 1.5 |
| Vulkanox HS | 1 |
| Vulkanox 4020 | 1 |
| Vulkacit CZ | 1.8 |
| Vulkacit D | 2 |
| Sulfur | 1.5 |

The rubbers according to the present invention and the comparison rubbers were used as “3^{rd} rubber”.

Information about the mixture components used:

TSR 5, Defo 700 (natural rubber)

Buna® CB 25 (polybutadiene, manufacturer Bayer AG)

Vulkasil® S (active silica, produced by Bayer AG)

Si 69 (bis-3-(triethoxysilylpropyl)tetrasulfide, manufacturer Degussa AG)

Corax® N121 (carbon black, manufacturer Degussa AG)

Enerthene 1849-1® (mineral oil plasticizer, manufacturer Mobil Schmierstoff GmbH)

ZnO RS® (manufacturer Bayer AG)

Antilux 654® (light stabilization wax, manufacturer Rhein-Chemie GmbH)

Vulkanox® HS (polymerized 2,2,4-trimethyl-1,2-dihydroquinoline, manufacturer Bayer AG)

Vulkanox® 4020 (N-(1,3-dimethylbutyl)-N′-phenyl-p-phenylenediamine, manufacturer Bayer AG)

Vulkacit® CZ (N-cyclohexyl-2-benzothiazyl-su Ifenamide, manufacturer Bayer AG)

Vulkacit® D (diphenylguanidine, manufacturer Bayer AG)

The following results were obtained:

TABLE 5

| | | Comparison | Example | Example | Example | Example | Example |
|---|---|---|---|---|---|---|---|
| | | Example 9 | 1 | 2 | 3 | 4 | 5 |
| Unvulcanized polymer ML 1 + 4 | (ME) | 51 | 62 | 64 | 59 | 80 | 66 |
| Tensile strength | (Mpa) | 20.5 | 19.2 | 18.1 | 13.9 | 19.6 | 17.2 |
| Elongation at break | (%) | 620 | 450 | 405 | 330 | 495 | 445 |
| Modulus 100 | (Mpa) | 2.1 | 2.7 | 3 | 3 | 2.4 | 2.1 |
| Modulus 200 | (Mpa) | 4.4 | 6.7 | 7.6 | 7.2 | 5.8 | 5.4 |
| Hardness 70° C. | (ShoreA) | 67 | 65 | 67 | 68 | 64 | 63 |
| DIN abrasion 60 | (mm³) | 90 | 85 | 70 | 65 | 55 | 70 |
| Index tan δ 0° C. | | 100 | 107 | 120 | 82 | 101 | 109 |
| Index tan δ 60° C. | | 100 | 122 | 114 | 130 | 111 | 114 |

Index > 100 = better

The index values listed in this and the following table for the tan δ values at 0° C. and 60° C. were determined as follows: Index tan δ value at 0° C.=tan δ value of the example according to the present invention/tan δ value of the comparison example×100. Index tan δ at 60° C.=tan δ value of the comparison example/tan δ value of the example according to the present invention×100.

It is known to the person skilled in the art that a high tan δ value at 0° C. indicates good skid resistance in the wet, whereas a low tan δ value at 60° C. represents a lower rolling resistance. As Table 5 shows, the rubbers according to the present invention exhibit advantages in the properties of skid resistance in the wet (tan δ60° C.) and rolling resistance (tan δ60° C.) with comparable hardness over a SBR produced in solution. The same applies to the abrasion.

TABLE 6

| | | Comparison | Example | Example | Example | Example | Example |
|---|---|---|---|---|---|---|---|
| | | Example 10 | 1 | 2 | 3 | 4 | 5 |
| Unvulcanized polymer ML 1 + 4 | (ME) | 49 | 62 | 64 | 59 | 80 | 66 |
| Tensile strength | (Mpa) | 19.8 | 19.2 | 18.1 | 13.9 | 19.6 | 17.2 |
| Elongation at break | (%) | 615 | 450 | 405 | 330 | 495 | 445 |
| Modulus 100 | (Mpa) | 2.1 | 2.7 | 3 | 3 | 2.4 | 2.1 |
| Modulus 200 | (Mpa) | 4.4 | 6.7 | 7.6 | 7.2 | 5.8 | 5.4 |
| Hardness 70° C. | (ShoreA) | 64 | 65 | 67 | 68 | 64 | 63 |
| DIN abrasion 60 | (mm³) | 100 | 85 | 70 | 65 | 55 | 70 |
| Index tan δ 0° C. | | 100 | 92 | 103 | 70 | 86 | 93 |
| Index tan δ 60° C. | | 100 | 127 | 119 | 136 | 116 | 120 |

Index > 100 = better

Table 6 shows that the rubbers according to the present invention are superior to an ESBR in the properties of rolling resistance (tan 60° C.) and abrasion.

TABLE 7

| | | Comparison | Example |
|---|---|---|---|
| | | Example 11 | 2 |
| Unvulcanized polymer ML 1 + 4 | (ME) | 68 | 64 |
| Tensile strength | (Mpa) | 20 | 18.1 |
| Elongation at break | (%) | 505 | 405 |
| Modulus 100 | (Mpa) | 2.6 | 3 |
| Modulus 200 | (Mpa) | 5.7 | 7.6 |
| Hardness 70° C. | (Shore A) | 65 | 67 |
| DIN abrasion 60 | (mm³) | 85 | 70 |
| Index tan δ 0° C. | | 100 | 127 |
| Index tan δ 60° C. | | 100 | 84 |

Index > 100 = better

A comparison with 2-vinylpyridine-containing ESBR shows that the rubber according to the present invention is superior to the rubber produced in accordance with EP 0 926 192 and EP 0 819 731 in the properties of abrasion and skid resistance in the wet (tan 6 0° C.) (Table 7).

Examples 7 and 8 were tested in the following mixture:

TABLE 8

| | | |
|---|---|---|
| SBR 1500 | 100 | 80 |
| Rubbers according to the invention | 0 | 20 |
| Vulkasil S | 50 | 50 |
| Si 69 | 6 | 6 |
| Aromatic Oil | 20 | 20 |
| Stearic Acid | 2 | 2 |
| Zinc Oxide | 3 | 3 |
| Vulkanox 4010 NA | 1 | 1 |
| Vulkanox 4020 | 1 | 1 |
| Sulphur | 2 | 2 |
| Sulphur | 2 | 2 |
| Vulkacit CZ | 1.5 | 1.5 |
| Vulkacit D | 0.2 | 0.2 |

The results are summarized in Table 9.

TABLE 9

| | | Comparison | Example | Example |
|---|---|---|---|---|
| | | Example 10 | 7 | 8 |
| Unvulcanized polymer | (ME) | 49 | 46 | 58 |
| ML 1 + 4 | | | | |
| Tensile strength | (Mpa) | 26.1 | 26.6 | 23.7 |
| Elongation at break | (%) | 580 | 540 | 510 |
| Modulus 100 | (Mpa) | 2.1 | 2.3 | 2.3 |
| Modulus 300 | (Mpa) | 9.1 | 10.3 | 10.1 |
| Hardness 70° C. | (Shore A) | 57 | 61 | 60 |
| DIN abrasion 60 | (mm3) | 80 | 76 | 81 |
| Index tan δ 0° C. | | 100 | 145 | 127 |
| Index tan δ 0° C. | | 100 | 159 | 158 |

The results in table 9 show that in the rubbers according to the present invention the components butadiene, styrene and acrylonitrile can be widely varied. The mixture of the examples according to the present invention are superior to the prior art in the properties of skid resistance in the wet (tan δ0° C.) and rolling resistance (tan δ60° C.).

The examples show that with the rubbers according to the present invention, the person skilled in the art is given materials which allow him to find suitable solutions to his development aims.

4. Tests in carbon black mixtures.

The following mixture was used

TABLE 10

| | |
|---|---|
| Krynol 1712 | 68.75 |
| 2^{nd} rubber | 50 |
| Renopal 450 | 18 |
| Carbon black N339 | 77 |
| ZnO | 3 |
| Stearic acid | 1.5 |
| Vulkanox 4020 | 2.5 |
| Vulkanox HS | 1.5 |
| Vulkacit NZ | 1.2 |
| Sulfur | 1.5 |

The rubbers according to the present invention and the comparison rubbers were used as “2^{nd} rubber”.

Information about the mixture components used:

Krynol® 1712 (SBR emulsion, 23.5 phr highly aromatic mineral oil, 23.5% styrene, manufacturer Bayer AG)

Renopal® 450 (aromatic mineral oil plasticizer, manufacturer Fuchs Chemie)

Corax®N339 (carbon black, manufacturer Degussa Ag) ZnO

Vulkanox® 4020 (N-(1,3-dimethylbutyl)-N′-phenyl-p-phenylenediamine, manufacturer Bayer AG)

Vulkanox® HS (polymerized 2,2,4-trimethyl-1,2-dihydroquinoline, manufacturer Bayer AG)

Vulkacit® NZ (N-tert. butyl-benzothiazyl-sulfenamide, manufacturer Bayer AG)

TABLE 11

| | | Comparison | Comparison | Example | Example |
|---|---|---|---|---|---|
| | | Example 10 | Example 12 | 2 | 6 |
| Unvulcanized polymer ML 1 + 4 at 100° C. | (ME) | 49 | 78 | 70 | 44 |
| Tensile strength | (Mpa) | 16.8 | 21.9 | 23.7 | 22.8 |
| Elongation at break | (%) | 820 | 720 | 710 | 730 |
| Modulus 100 | (Mpa) | 1.1 | 1.3 | 1.7 | 1.6 |
| Modulus 300 | (Mpa) | 4.2 | 6.3 | 7.9 | 7.2 |
| Index tan δ 0° C. | | 100 | 108 | 125 | 118 |
| Index tan δ 60° C. | | 100 | 107 | 106 | 108 |

Index > 100 = better

The results in Table 11 show that the rubbers according to the present invention are superior to a commercially available ESBR both in the skid resistance in the wet (tan δ0° C.) and in the rolling resistance (tan δ60° C.). Compared with a terpolymer consisting of butadiene, styrene and acrylonitrile (DE-A 19 643 035), the rubbers according to the present invention exhibit improved skid resistance in the wet (tan δ0° C.) with the same degree of rolling resistance (tan δ60° C.).

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

What is claimed is:

1. Quaternary polymers comprising:
a) 40 to 95 wt. % of a conjugate diene;
b) 1 to 30% of a vinyl-substituted aromatic;
c) 1 to 30 wt. % of an olefinically unsaturated nitrile; and
d) 0.1 to 20 wt. % of an amino group-containing monomer,
wherein the components a) to d) add up to 100 wt. % in each case.

2. Quarternary polymers according to claim 1, wherein said conjugate diene is selected from the group consisting of 1,3-butadiene, isoprene, chloroprene, 1,3-pentadiene, 2,3-dimethyl-1,3-butadiene, 2-methyl-1,3-pentadiene and 2,3-dimethyl-1,3-pentadiene and mixtures thereof.

3. Quarternary polymers according to claim 1, wherein said vinyl-substituted aromatic are selected from the group consisting of styrene, α-methylstyrene, p-methylstyrene, 1-vinylnaphthalene, p-chlorostyrene, p-bromostyrene and mixtures thereof.

4. Quarternary polymers according to claim 1, wherein said olefinically unsaturated nitrile is selected from the group consisting of acrylonitrile, methacrylonitrile, 3-butenenitrile, 4-pentenenitrile and mixtures thereof.

5. A process for producing the quaternary polymers wherein said quarternary polymer comprises the following:
a) 40 to 95 wt. % of a conjugate diene;
b) 1 to 30% of a vinyl-substituted aromatic;
c) 1 to 30 wt. % of an olefinically unsaturated nitrile; and
d) 0.1 to 20 wt. % of an amino group-containing monomer,
wherein the components a) to d) add up to 100 wt. % in each case, said process comprising the step of polymerizing the monomer in emulsion

6. Molded articles comprising quaternary polymers, which comprises:
a) 40 to 95 wt. % of a conjugate diene;
b) 1 to 30% of a vinyl-substituted aromatic;
c) 1 to 30 wt. % of an olefinically unsaturated nitrile; and
d) 0.1 to 20 wt. % of an amino group-containing monomer,
wherein the components a) to d) add up to 100 wt. % in each case.

7. Molded articles according to claim 6, wherein said molded article is a tire, belt, tube or seal.

8. Rubber mixtures comprising
a) quaternary polymers, which comprises:
i) 40 to 95 wt. % of a conjugate diene;
ii) 1 to 30% of a vinyl-substituted aromatic;
iii) 1 to 30 wt. % of an olefinically unsaturated nitrile; and
iv) 0.1 to 20 wt. % of an amino group-containing monomer,
wherein the components i) to iv) add up to 100 wt. % in each case, and
b) other natural or synthetic rubbers or mixtures of natural or synthetic rubbers and optionally fillers, crosslinking agents and other auxiliary agents which improve the rubber properties.

9. Molded articles comprising rubber mixtures including
a) quaternary polymers, which comprises:
i) 40 to 95 wt. % of a conjugate diene;
ii) 1 to 30% of a vinyl-substituted aromatic;
iii) 1 to 30 wt. % of an olefinically unsaturated nitrile; and
iv) 0.1 to 20 wt. % of an amino group-containing monomer,
wherein the components i) to iv) add up to 100 wt. % in each case, and
b) other natural or synthetic rubbers or mixtures of natural or synthetic rubbers and optionally fillers, crosslinking agents and other auxiliary agents which improve the rubber properties.

10. Molded article according to claim 9, wherein said molded article is produced in a shaping manner by vulcanization.
